(19) United States
(12) Patent Application Publication
(10) Pub. No.: US 2016/0070187 A1
(43) Pub. Date: Mar. 10, 2016

(54) ELECTROSTATIC CHARGE IMAGE DEVELOPING TONER, ELECTROSTATIC CHARGE IMAGE DEVELOPER, AND TONER CARTRIDGE

(71) Applicant: FUJI XEROX CO., LTD., Tokyo (JP)

(72) Inventors: Yuka KAWAMOTO, Kanagawa (JP); Daisuke ISHIZUKA, Kanagawa (JP); Yuki TAKAMIYA, Kanagawa (JP); Noriyuki MIZUTANI, Kanagawa (JP)

(21) Appl. No.: 14/602,613

(22) Filed: Jan. 22, 2015

(30) Foreign Application Priority Data
Sep. 4, 2014 (JP) 2014-180213

(51) Int. Cl. G03G 9/00

(52) U.S. Cl. CPC G03G 9/08755; G03G 9/10

(57) ABSTRACT

An electrostatic charge image developing toner includes toner particles containing a binder resin that contains a polyester resin having an ethylenically unsaturated double bond, a di- or higher valent metal ion, and (meth)acrylic acid alkyl ester that has an alkyl chain having 1 to 10 carbon atoms, wherein a content of the (meth)acrylic acid alkyl ester is in a range of 50 ppm to 500 ppm with respect to toner particles.

### CROSS-REFERENCE TO RELATED APPLICATIONS

This application is based on and claims priority under 35 USC 119 from Japanese Patent Application No. 2014-180213 filed Sep. 4, 2014.

### BACKGROUND

### Technical Field

The present invention relates to an electrostatic charge image developing toner, an electrostatic charge image developer, and a toner cartridge.

### SUMMARY

According to an aspect of the invention, there is provided an electrostatic charge image developing toner, including toner particles containing a binder resin that contains a polyester resin having an ethylenically unsaturated double bond, a di- or higher valent metal ion, and (meth)acrylic acid alkyl ester that has an alkyl chain having 1 to 10 carbon atoms, wherein a content of the (meth)acrylic acid alkyl ester is in a range of 50 ppm to 500 ppm with respect to toner particles.

### BRIEF DESCRIPTION OF THE DRAWINGS

Exemplary embodiments of the present invention will be described in detail based on the following figures, wherein:

FIG. 1 is a view schematically illustrating an example of a configuration of an image forming apparatus according to the present exemplary embodiment; and

FIG. 2 is a view schematically illustrating an example of a configuration of a process cartridge according to the present exemplary embodiment.

### DETAILED DESCRIPTION

Hereinafter, exemplary embodiments which are examples of the present invention will be described in detail.

Electrostatic Charge Image Developing Toner

An electrostatic charge image developing toner (hereinafter, referred to as a “toner”) according to the present exemplary embodiment includes toner particles. The toner may include an external additive if necessary.

Further, the toner particles contain a binder resin containing a polyester resin which has an ethylenically unsaturated double bond (hereinafter, also referred to as an “unsaturated polyester resin”), a di- or higher valent metal ion, and (meth)) acrylic acid alkyl ester which has an alkyl chain having 1 to 10 carbon atoms. The content of (meth)acrylic acid alkyl ester is in the range of 50 ppm to 500 ppm with respect to the toner.

Here, in the related art, a toner using a polyester resin as a binder resin is known. The glossiness of an image formed by this toner may be changed on occasion when the temperature in a vehicle or the like is increased and the image is kept in the environment exposed to ultraviolet rays of solar light. Specifically, when a molecular chain of a polyester resin in an image is cut due to heat and ultraviolet rays and the molecular weight is decreased, the surface properties of the image becomes smooth and has high glossiness, or deterioration of a polyester resin in the image progresses due to heat and ultraviolet rays so that the surface of the image becomes rough and has low glossiness.

On the contrary, in the toner according to the present exemplary embodiment, a change in gloss (glossiness) of an image which is formed in the case where the image is kept in an environment exposed to a high temperature and ultraviolet rays is prevented using the above-described configuration. The reason is not clear, but it is assumed that the reason thereof is as follows.

An image formed by the toner according to the present exemplary embodiment contains a di- or higher valent metal ion and (meth)acrylic acid alkyl ester in a state of being dispersed in an unsaturated polyester resin. Molecular motion of a low molecular component in a resin is activated at a high temperature so that a precipitation phenomenon (hereinafter, also referred to as “bleed”) of the low molecular component easily occurs. Accordingly, (meth)acrylic acid alkyl ester with an alkyl chain having a small number of carbon atoms of 1 to 10 becomes easily present in the surface portion of the image at a high temperature. As a result, it is considered that (meth)acrylic acid alkyl ester is decomposed due to a complex stimulation of heat and ultraviolet rays and thus a (meth)acrylic acid radical is formed.

It is considered that, in the surface layer portion of an image, the (meth)acrylic acid radical is cross-linked with a di- or higher valent metal ion and ethylenic double bond portion of an unsaturated polyester resin and, as a result, a fine three-dimensional cross-linked structure is formed on the surface layer portion of an image. Accordingly, even when an image is exposed to heat and ultraviolet rays, a molecular chain of a polyester resin is unlikely cut and deterioration thereof unlikely occurs and thus a change in surface properties such as roughness of an image is prevented.

When the content of (meth)acrylic acid alkyl ester is controlled to be in the above-described range, it is possible to prevent the concentration of (meth)acrylic acid alkyl ester bleeding on the surface layer portion of an image from being excessively high. That is, a polymerization reaction between (meth)acrylic) acrylic acid alkyl esters due to the formed (meth)acrylic acid radical becomes unlikely to occur on the surface layer portion of an image and the (meth)acrylic acid radical easily contributes to crosslinking between metal ions and a polyester resin.

As described above, it is considered that the toner according to the present exemplary embodiment prevents a change in gloss (glossiness) of an image which is formed when the image is kept in an environment exposed to a high temperature and ultraviolet rays.

Hereinafter, the toner according to the present exemplary embodiment will be described in detail.

The toner according to the present exemplary embodiment includes toner particles. The toner may include an external additive to be attached to the surface of the toner particles if necessary.

Toner Particles

The toner particles include a binder resin, a di- or higher valent metal ion, and (meth)acrylic acid alkyl ester. The toner particles may include a colorant, a release agent, and other additives if necessary.

Binder Resin

The binder resin includes an unsaturated polyester resin. The unsaturated polyester resin is a polyester resin having an ethylenically unsaturated double bond (for example, a vinyl group or a vinylene group) in a molecule.

Specifically, examples of the unsaturated polyester resin include a polyester resin which is a polycondensate of polyvalent carboxylic acid and polyol and uses a monomer having an ethylenically unsaturated double bond to be an unsaturated polyester component as at least one of polyvalent carboxylic acid and polyol.

Particularly, in regard to the unsaturated polyester resin, from a viewpoint of stability, a polycondensate of polyvalent carboxylic acid having an ethylenically unsaturated double bond and polyol is preferable and a polycondensate (that is, a linear polyester resin) of divalent carboxylic acid having an ethylenically unsaturated double bond (for example, a vinyl group or a vinylene group) and divalent alcohol is more preferable as an amorphous unsaturated polyester resin.

In addition, in the case where the unsaturated polyester resin is a polycondensate of polyvalent carboxylic acid having an ethylenically unsaturated double bond and polyol, polyvalent carboxylic acid having no ethylenically unsaturated double bond may be used as a part of polyvalent carboxylic acid if necessary.

Examples of the divalent carboxylic acid having an ethylenically unsaturated double bond include fumaric acid, maleic acid, maleic anhydride, citraconic acid, mesaconic acid, itaconic acid, glutaconic acid, allylmalonic acid, isopropylidene succinic acid, acetylene dicarboxylic acid, and lower (having 1 to 4 carbon atoms) alkyl esters of these.

Examples of trivalent or higher carboxylic acid having an ethylenically unsaturated double bond include aconitic acid, 3-butene-1,2,3-tricarboxylic acid, 4-pentene-1,2,4-tricarboxylic acid, 1-pentene-1,1,4,4-tetracarboxylic acid, and lower (having 1 to 4 carbon atoms) alkyl esters of these.

Examples of polyvalent carboxylic acid having no ethylenically unsaturated double bond include aliphatic dicarboxylic acid such as oxalic acid, succinic acid, glutaric acid, adipic acid, suberic acid, azelaic acid, sebacic acid, 1,9-nonane dicarboxylic acid, 1,10-decane dicarboxylic acid, 1,12-dodecane dicarboxylic acid, 1,14-tetradecane dicarboxylic acid, or 1,18-octadecane dicarboxylic acid; and aromatic dicarboxylic acid such as phthalic acid, isophthalic acid, terephthalic acid, or naphthalene-2,6-dicarboxylic acid.

These polyvalent carboxylic acids may be used alone or in combination of two or more kinds thereof.

Examples of divalent alcohol include bisphenol A, hydrogenated bisphenol A, an alkylene (having 2 to 4 carbon atoms) oxide adduct of bisphenol A (average addition molar number of 1.5 to 6: for example, polyoxypropylene(2.2)-2,2-bis(4-hydroxyphenyl) propane, or polyoxyethylene(2.2)-2,2-bis(4-hydroxyphenyl)propane), 1,4-cyclohexanediol, 1,4-cyclohexanedimethanol, ethylene glycol, diethylene glycol, propylene glycol, dipropylene glycol, 1,3-butanediol, 1,4-butanediol, 1,5-pentanediol, 1,6-hexanediol, 1,9-nonanediol, and neopentyl glycol.

Examples of trivalent or higher alcohol include glycerin, trimethylol ethane, trimethylol propane, and pentaerythritol.

Further, for the purpose of adjusting the acid value and the hydroxyl value, monovalent acid such as acetic acid or benzoic acid; and monovalent alcohol such as cyclohexanol or benzyl alcohol may be used in combination together with polyol according to the necessity.

The polyol may be used alone or in combination of two or more kinds thereof.

Among unsaturated polyester resins which are polycondensates of these polyvalent carboxylic acids and polyols, particularly, a polycondensate of at least one kind of divalent carboxylic acid selected from the group consisting of fumaric acid, maleic acid, and maleic anhydride and divalent alcohol is preferable.

The ratio of monomers having an ethylenically unsaturated double bond to a total amount of polyvalent carboxylic acid and polyol of an unsaturated polyester resin is preferably in the range of 5% by mole to 25% by mole and more preferably in the range of 10% by mole to 22.5% by mole.

Further, the ratio of monomers (polyvalent carboxylic acid) having an ethylenically unsaturated double bond to a total amount of polyvalent carboxylic acid is in the range of 12.5% by mole to 60% by mole and more preferably in the range of 12.5% by mole to 45% by mole.

The ethylenically unsaturated double bond equivalent of the unsaturated polyester resin is preferably 4000 g/eq or less, more preferably 1500 g/eq or less, and still more preferably 1000 g/eq or less.

Further, the ethylenically unsaturated double bond equivalent of a resin is a value measured by the following method. The molecular weight per one ethylenically unsaturated double bond is calculated by performing NMR analysis (H analysis) of a resin, identifying the kinds of monomers and the composition ratio thereof, and obtaining the ratio of monomers having an ethylenically unsaturated double bond among those identified monomers.

The glass transition temperature (Tg) of the unsaturated polyester resin is preferably in the range of 50° C. to 80° C. and more preferably in the range of 50° C. to 65° C.

In addition, the glass transition temperature is obtained using a DSC curve obtained by differential scanning calorimetry (DSC) and, more specifically, the glass transition temperature is determined based on “the extrapolated glass transition starting temperature” described in a method of obtaining the glass transition temperature, JIS K7121-1987 “Testing Methods for Transition Temperatures of Plastics”.

The weight average molecular weight (Mw) of the unsaturated polyester resin is preferably in the range of 5000 to 1000000, more preferably in the range of 7000 to 500000.

The number average molecular weight (Mn) of the unsaturated polyester resin is preferably in the range of 2000 to 100000.

The molecular weight distribution Mw/Mn of the unsaturated polyester resin is preferably in the range of 1.5 to 100 and more preferably in the range of 2 to 60.

Further, the weight average molecular weight and the number average molecular weight are measured by a gel permeation chromatography (GPC). Measurement of the molecular weight using GPC is performed in a THF solvent using HLC-8120 (GPC manufactured by Tosoh Corporation) as a measuring device and TSKgel SuperHM-M (15 cm) (column manufactured by Tosoh Corporation). The weight average molecular weight and the number average molecular weight are calculated using a molecular weight calibration curve created by a monodisperse polystyrene standard sample from the measurement results.

The unsaturated polyester resin may be obtained by a known production method. Specifically, the unsaturated polyester resin may be obtained by a method including: setting a polymerization temperature at 180° C. to 230° C., and performing a reaction while reducing the pressure in a reaction system according to the necessity, and then removing water or alcohol generated during condensation.

In a case where a monomer as a raw material is not dissolved or compatible at the reaction temperature, the monomer may be dissolved by adding a solvent having a high boiling point as a solubilizing agent. In this case, the polycondensation reaction is performed while the solubilizing agent is distilled. In a case where a monomer with poor compatibility is present in the polycondensation reaction, the monomer with poor compatibility and acids or alcohol to be polycondensed with the monomer are polycondensed in advance, and then polycondensation with the main component may be performed.

A binder resin containing an unsaturated polyester resin may contain other binder resin than the unsaturated polyester resin. In this case, the ratio of the unsaturated polyester resin to the entirety of the binder resin may be 50% by weight or more (preferably 70% by weight or more and more preferably 90% by weight or more).

Examples of other binder resins include vinyl resins (for example, a styrene acrylic resin) and non-vinyl resins (for example, an epoxy resin, a polyester resin having no ethylenically unsaturated double bond, a polyurethane resin, a polyamide resin, a cellulose resin, a polyether resin, and modified rosin).

The content of the binder resin is preferably in the range of 40% by weight to 95% by weight, more preferably in the range of 50% by weight to 90% by weight, and still more preferably in the range of 60% by weight to 90% by weight with respect to the entirety of toner particles.

Di- or Higher Valent Metal Ion

As a di- or higher valent metal ion (hereinafter, simply also referred to as a “metal ion”), divalent to tetravalent metal ions may be exemplified. Specifically, examples of the metal ions include at least one kind of metal ion selected from the group consisting of an aluminum ion, a magnesium ion, an iron ion, a zinc ion, and a calcium ion.

Examples of supply sources (compound contained in toner particles as an additive) of the metal ions include metal salts, an inorganic metal salt polymer, and a metal complex. In a case where toner particles are prepared using an aggregation and coalescence method, metal salts, an inorganic metal salt polymer, and a metal complex are added to toner particles as a coagulant.

Examples of the metal salts include aluminum sulfate, aluminum chloride, magnesium chloride, magnesium sulfate, iron chloride (II), zinc chloride, calcium chloride, and calcium sulfate.

Examples of the inorganic metal salt polymer include polyaluminum chloride, polyaluminum hydroxide, polyiron sulfate (II), and calcium polysulfide.

Examples of the metal complex include metal salts of aminocarboxylic acid. Specific examples of the metal complex include metal salts (for example, calcium salts, magnesium salts, iron salts, and aluminum salts) having known chelate such as ethylene diamine tetra-acetic acid, propane diamine tetra-acetic acid, nitrile tri-acetic acid, triethylene tetramine hexa-acetic acid, or diethylene triamine penta-acetic acid as a base component.

Moreover, the supply sources of these metal ions may be added not for use as a coagulant but simply as an additive.

As the valence of metal ions is higher, mesh-like ion-crosslinking becomes easy to be formed, and ions of a metallic element having a smaller atomic number are small and a mesh structure of crosslinking becomes small accordingly, which is preferable in terms of preventing a change in glossiness of an image. For this reason, as metal ions, trivalent or higher valent metal ions (particularly Al ions) are preferable. That is, as the supply sources of the metal ions, aluminum salts (for example, aluminum sulfate and aluminum chloride) and an aluminum salt polymer (for example, polyaluminum chloride or polyaluminum hydroxide) are preferable. Further, in terms of preventing a change in glossiness of an image, even when metal ions have the same valence, among the supply sources of the metal ions, an inorganic metal salt polymer is preferable compared to metal salts.

The content of the metal ions is preferably in the range of 0.005% by weight to 0.800% by weight, more preferably in the range of 0.010% by weight to 0.10% by weight, and still more preferably in the range of 0.05% by weight to 0.08% by weight in the toner (with respect to the entirety of the toner) in terms of preventing a change in glossiness of an image.

The content of metal ions is measured by quantitatively analyzing the fluorescent X-ray intensity of toner particles. Specifically, first, a resin and a supply source of metal ions are mixed to obtain a resin mixture whose concentration of the metal ion is known. 200 mg of the resin mixture is made into a pellet sample using a tablet shaper having a diameter of 13 mm. Next, the weight of this pellet sample is accurately weighed, fluorescent X-ray intensity measurement is performed on the pellet sample, and then the peak intensity is obtained. Similarly, a pellet sample obtained by changing the addition amount of the supply source of metal ions to is measured and a calibration curve is created from the results. In addition, the content of metal ions in toner particles as a measurement target is quantitatively analyzed using a calibration curve.

Examples of a method of adjusting the content of metal ions include (1) a method of adjusting the amount of the supply source of metal ions and (2) a method of adjusting the content of metal ions, in a case where toner particles are prepared using an aggregation and coalescence method, by adding a coagulant (for example, metal salts or a metal salt polymer) as a supply source of metal ions in an aggregating process, adding a chelating agent (for example EDTA (ethylenediaminetetraacetic acid), DTPA (diethylenetriaminepentaacetic acid), or NTA (nitrilotriacetic acid)) at the end of the aggregating process, forming a complex with the metal ions using the chelating agent, and removing formed complex salts during a washing process or the like subsequent to the aggregating process.

(Meth)Acrylic Acid Alkyl Ester

(Meth)acrylic acid alkyl ester is (meth)acrylic acid alkyl ester whose alkyl chain has 1 to 10 carbon atoms.

Further, the expression of “(meth)acryl” or the like includes both of “acryl” and “methacryl.”

Examples of the (meth)acrylic acid alkyl ester include monofunctional (meth)acrylic acid alkyl ester which is an ester compound of (meth)acrylic acid and monovalent alcohol whose alkyl chain has 1 to 10 carbon atoms; and polyfunctional (meth)acrylic acid alkyl ester which is an ester compound of (meth)acrylic acid and polyol whose alkyl chain has 1 to 10 carbon atoms. As the (meth)acrylic acid alkyl ester, monofunctional (meth)acrylic acid alkyl ester is preferable in terms of preventing a change in glossiness of an image.

The alkyl chain of the (meth)acrylic acid alkyl ester may be linear, branched or cyclic, but the alkyl chain is preferably linear or branched and more preferably linear in terms of preventing a change in glossiness of an image.

The number of carbon atoms of the alkyl chain of the (meth)acrylic acid alkyl ester is preferably in the range of 3 to 6 and more preferably in the range of 3 to 5 in terms of preventing a change in glossiness of an image.

Examples of the monofunctional (meth)acrylic acid alkyl ester include methyl (meth)acrylate, ethyl (meth)acrylate, n-propyl (meth)acrylate, n-butyl (meth)acrylate, n-pentyl (meth)acrylate, n-hexyl (meth)acrylate, n-heptyl (meth)acrylate, n-octyl (meth)acrylate, n-decyl (meth)acrylate, isopropyl (meth)acrylate, isobutyl (meth)acrylate, t-butyl (meth)acrylate, isopentyl (meth)acrylate, amyl (meth)acrylate, neopentyl (meth)acrylate, isohexyl (meth)acrylate, isoheptyl (meth)acrylate, isooctyl (meth)acrylate, 2-ethylhexyl (meth)acrylate, octyl (meth)acrylate, decyl (meth)acrylate, cyclohexyl (meth)acrylate, and dicyclopentanyl (meth)acrylate.

Examples of polyfunctional(meth)acrylic acid alkyl ester include ethylene glycol di(meth)acrylate, diethylene glycol di(meth)acrylate, triethylene glycol di(meth)acrylate, butanediol di(meth)acrylate, pentanediol di(meth)acrylate, hexanediol di(meth)acrylate, nonanediol di(meth)acrylate, and decanediol di(meth)acrylate.

The content of the (meth)acrylic acid alkyl ester is in the range of 50 ppm to 500 ppm, preferably in the range of 100 ppm to 300 ppm, and more preferably in the range of 100 ppm to 200 ppm with respect to toner particles. Further, the content of the (meth)acrylic acid alkyl ester is on the weight basis.

The (meth)) acrylic acid alkyl ester is measured as follows. First, gas chromatography analysis is performed in advance on acrylic acid alkyl ester alone which is an analysis target, and the holding time of a target substance is examined and then quantified by creating a calibration curve. Further, gas chromatography analysis is performed on a toner (toner particles) which is a measurement target, and acrylic acid alkyl ester in the toner is determined based on the calibration curve.

Further, the conditions of the gas chromatography analysis are as follows.

Gas chromatography apparatus: GC-2010, manufactured by Shimadzu Corporation

Headspace sampler: TurboMatrix HS40, manufactured by PerkinElmer Co., Ltd.

Separation column: RTX-1, manufactured by Shimadzu GLC Ltd.

Condition of headspace: heating at 130° C. for 3 minutes

Condition of raising temperature of column: 10° C./min

Temperature of vaporizing chamber: 220° C.

Temperature of detector: 260° C.

Injection mode: split

Carrier gas: N₂

Amount of toner: 0.5 g

—Colorants—

Examples of colorants include various pigments such as Carbon Black, Chrome Yellow, Hansa Yellow, Benzidine Yellow, Threne Yellow, Quinoline Yellow, Pigment Yellow, Permanent Orange GTR, Pyrazolone Orange, Vulcan Orange, Watchung Red, Permanent Red, Brilliant Carmine 3B, Brilliant Carmine 6B, Du Pont Oil Red, Pyrazolone Red, Lithol Red, Rhodamine B Lake, Lake Red C, Pigment Red, Rose Bengal, Aniline Blue, Ultramarine Blue, Calco Oil Blue, Methylene Blue Chloride, Phthalocyanine Blue, Pigment Blue, Phthalocyanine Green, and Malachite Green Oxalate; and various dyes such as an acridine dye, a xanthene dye, an azo dye, a benzoquinone dye, an azine dye, an anthraquinone dye, a thioindigo dye, a dioxazine dye, a thiazine dye, an azomethine dye, an indigo dye, a phthalocyanine dye, an aniline black dye, a polymethine dye, a triphenylmethane dye, a diphenylmethane dye, and a thiazole dye.

These colorants may be used alone or in combination of two or more kinds thereof.

As the colorant, a colorant subjected to a surface treatment may be used according to the necessity or a combination with a dispersant may be used. In addition, the colorants may be used in combination of plural kinds thereof.

The content of the colorant is preferably in the range of 1% by weight to 30% by weight and more preferably in the range of 3% by weight to 15% by weight with respect to the entirety of toner particles.

—Release Agent—

Examples of the release agent include a hydrocarbon wax, natural waxes such as a carnauba wax, a rice wax, and a candelilla wax; synthetic or mineral and petroleum waxes such as a montan wax; and ester waxes such as fatty acid ester and montan acid ester. However, the release agents are not limited to these examples.

The melting temperature of the release agent is preferably in the range of 50° C. to 110° C. and more preferably in the range of 60° C. to 100° C.

Further, the melting temperature is obtained from a “melting peak temperature” described in a method of acquiring the melting temperature in JIS K-1987 “Testing Methods for Transition Temperatures of Plastics” based on a DSC curve obtained using differential scanning calorimetry (DSC).

The content of the release agent is preferably in the range of 1% by weight to 20% by weight and more preferably in the range of 3% by weight to 15% by weight with respect to the entirety of toner particles.

—Other Additives—

Examples of other additives include known additives such as a magnetic material, a charge-controlling agent, and inorganic particles. These additives are contained in toner particles as internal additives.

—Characteristics of Toner Particles—

The toner particles may have a single layer structure or a so-called core-shell structure formed of a core (core particles) and a coating layer (shell layer) covering the core.

Here, the toner particles having a core-shell structure may preferably be formed of a core containing a binder resin and other additives such as a colorant and a release agent according to the necessity; and a coating layer containing a binder resin.

In addition, a divalent metal ion and (meth)acrylic acid alkyl ester are respectively contained at least one of a core and a coating portion.

The volume average particle diameter (D50v) of the toner particles is preferably in the range of 2 μm to 15 μm and more preferably in the range of 3 μm to 9 μm.

In addition, various average particle diameters and various particle size distribution indices of toner particles are measured using Coulter Multisizer-II (manufactured by BECKMAN COULTER) and ISOTON-II (manufactured by BECKMAN COULTER) is used as an electrolyte solution.

During the measurement, a measurement sample is added to 2 mL of a 5% aqueous solution of a surfactant (sodium alkylbenzene sulfonate is preferable) as a dispersant by an amount of 0.5 mg to 50 mg. The solution is added to 100 mL to 150 mL of an electrolyte solution.

The electrolyte in which the sample is suspended is subjected to a dispersion treatment in an ultrasonic disperser for 1 minute, and the particle size distribution of particles having a particle diameter in the range of 2 μm to 60 μm is measured with Coulter Multisizer-II using an aperture having an aperture diameter of 100 μm. Further, the number of particles for sampling is 50000.

Cumulative distributions of the volume and the number are drawn from the small diameter side with respect to the particle size range (channel) divided based on the measured particle size distribution, and the particle diameter corresponding to 16% cumulation is defined as a volume particle diameter D16v and a number particle diameter D16p, the particle diameter corresponding to 50% cumulation is defined as a volume average particle diameter D50v and a cumulative number average particle diameter D50p, and the particle diameter corresponding to 84% cumulation is defined as a volume particle diameter D84v and a number particle diameter D84p.

Using these definitions, the volume average particle size distribution index (GSDv) is calculated as (D84v/D16v)^{1/2} and the number average particle size distribution index (GSDp) is calculated as (D84p/D16p)^{1/2}.

A shape factor SF1 of the toner particles is preferably in the range of 110 to 150 and more preferably in the range of 120 to 140.

In addition, the shape factor SF1 is determined by the following equation.

Equation: SF1=(ML²/A)×(π/4)×100

In the equation, ML represents a maximum absolute length of a toner and A represents a projected area of a toner.

Specifically, the shape factor SF1 is digitized by mainly analyzing a microscope image or a scanning electron microscope (SEM) image using an image analyzer and is calculated as follows. That is, an optical microscope image of particles sprayed on the surface of slide glass is captured in an image analyzer (Luzex) by a video camera, the maximum length and the projected area of one hundred particles are obtained, and calculation is performed using the above equation, and then the average value thereof is obtained, thereby obtaining the shape factor.

External Additives

As the external additive, inorganic particles are exemplified. Examples of the inorganic particles include SiO₂, TiO₂, Al₂O₃, CuO, ZnO, SnO₂, CeO₂, Fe₂O₃, MgO, BaO, CaO, K₂O, Na₂O, ZrO₂, CaO.SiO₂, K₂O.(TiO₂)n, Al₂O₃.2SiO₂, CaCO₃, MgCO₃, BaSO₄, and MgSO₄.

The surface of inorganic particles as an external additive may preferably be subjected to a hydrophobic treatment. The hydrophobic treatment is performed by dipping the inorganic particles in a hydrophobizing agent. The hydrophobizing agent is not particularly limited, and examples thereof include a silane coupling agent, silicone oil, a titanate coupling agent, and an aluminum coupling agent. These may be used alone or in combination of two or more kinds thereof.

The amount of the hydrophobizing agent is generally in the range of 1 part by weight to 10 parts by weight with respect to 100 parts by weight of the inorganic particles.

Examples of the external additive include resin particles (particles of resins such as polystyrene, PMMA, and a melamine resin) and cleaning activators (metal salts of higher fatty acids represented by zinc stearate and particles of a fluorine polymer).

The amount of the external additive to be externally added is preferably in the range of 0.01% by weight to 5% by weight and more preferably in the range of 0.01% by weight to 2.0% by weight with respect to toner particles.

Method of Producing Toner

Next, a method of producing a toner according to the present exemplary embodiment will be described.

The toner according to the present exemplary embodiment may be obtained by externally adding an external additive to toner particles after the toner particles are produced.

The toner particles may be produced using a dry method (for example, a kneading and pulverizing method) or a wet method (for example, an aggregation and coalescence method, a suspension polymerization method, or a dissolution suspension method). The method of producing toner particles is not particularly limited, and a known method is employed.

Among these, the toner particles may be obtained using an aggregation and coalescence method.

Specifically, for example, in the case where toner particles are produced using the aggregation and coalescence method, toner particles are produced by performing a process of preparing a resin particle dispersion in which resin particles, which become a binder resin, are dispersed (resin particle dispersion preparation process); a process of aggregating resin particles (other particles according to the necessity) in the resin particle dispersion (in a dispersion after mixing other particle dispersion according to the necessity) and forming aggregated particles (aggregated particles forming process); and a process of heating the aggregated particle dispersion in which aggregated particles are dispersed, coalescing the aggregated particles, and forming toner particles (coalescence process).

Here, in the aggregation and coalescence method, (meth)) acrylic acid alkyl ester is added to a dispersion during at least one process among the above-described processes. Further, in a case where toner particles having a core-shell structure described below are produced, (meth)acrylic acid alkyl ester may be added to each dispersion after the aggregated particle dispersion in which aggregated particles are dispersed.

Hereinafter, details of respective processes will be described.

In the description below, a method of obtaining toner particles containing a colorant and a release agent will be described, but the colorant and the release agent are used according to the necessity. Other additives than the colorant and the release agent may be used.

Resin Particle Dispersion Preparation Process

First, for example, a colorant particle dispersion in which colorant particles are dispersed and a release agent particle dispersion in which release agent particles are dispersed are prepared together with the resin particle dispersion in which resin particles which become a binder resin are dispersed.

Here, the resin particle dispersion is prepared by dispersing resin particles in a dispersion medium using a surfactant.

As a dispersion medium used for the resin particle dispersion, an aqueous medium may be exemplified.

Examples of the aqueous medium include water such as distilled water or ion exchange water, and alcohol. They may be used alone or in combination of two or more kinds thereof.

Examples of the surfactant include anionic surfactants such as a sulfate ester salt anionic surfactant, a sulfonate anionic surfactant, a phosphate ester anionic surfactant, and a soap anionic surfactant; cationic surfactants such as an amine salt cationic surfactant and a quaternary ammonium salt cationic surfactant; and non-ionic surfactants such as a polyethylene glycol non-ionic surfactant, an alkyl phenol ethylene oxide adduct non-ionic surfactant, and a polyol non-ionic surfactant. Particularly, among these, anionic surfactants and cationic surfactants may be exemplified. The non-ionic surfactants may be used in combination with anionic surfactants or cationic surfactants.

The surfactants may be used alone or in combination of two or more kinds thereof.

Regarding the resin particle dispersion, examples of the method of dispersing resin particles in a dispersion medium include general dispersion methods using a rotary shearing type homogenizer, a ball mill having media, a sand mill, and a dynomill. Further, resin particles may be dispersed in the resin particle dispersion using, for example, a phase inversion emulsification method depending on the kind of resin particles.

In addition, the phase inversion emulsification method is a method which includes dissolving a resin to be dispersed in a hydrophobic organic solvent in which the resin is soluble, adding a base to an organic continuous phase (O phase) to be neutralized, and putting an aqueous medium (W phase) thereto such that the resin is converted (so-called phase inversion) from W/O to O/W to form a discontinuous phase, thereby dispersing a resin in an aqueous medium in a particle shape.

The volume average particle diameter of the resin particles to be dispersed in the resin particle dispersion is preferably in the range of 0.01 μm to 1 μm, more preferably in the range of 0.08 μm to 0.8 μm, and still more preferably in the range of 0.1 μm to 0.6 μm.

Further, the volume average particle diameter of the resin particles is measured by drawing cumulative distribution of the volume from the small diameter side with respect to the divided particle size range (channel) based on the particle size distribution obtained by measurement using a laser diffraction particle size distribution measuring device (for example, LA-700, manufactured by Horiba, Ltd.) and defining the particle diameter corresponding to 50% cumulation with respect to the entirety of particles as a volume average particle diameter D50v. Further, the volume average particle diameters of particles of other dispersions are measured in the same manner.

The content of the resin particles contained in the resin particle dispersion is preferably in the range of 5% by weight to 50% by weight and more preferably in the range of 10% by weight to 40% by weight.

Moreover, in the same manner as the resin particle dispersion, for example, the colorant particle dispersion and the release agent particle dispersion are produced. That is, in regard to the volume average particle diameter of particles in the resin particle dispersion, the dispersion medium, the dispersion method, and the content of the particles, the same shall apply to colorant particles dispersed in the colorant particle dispersion and release agent particles dispersed in the release agent particle dispersion.

Aggregated Particle Forming Process

Next, the colorant particle dispersion and the release agent particle dispersion are mixed together with the resin particle dispersion.

Further, the resin particles, the colorant particles, and the release agent particles are hetero-aggregated in the mixed dispersion and aggregated particles having a diameter close to the target diameter of toner particles and including resin particles, colorant particles, and release agent particles are formed.

Specifically, for example, a coagulant is added to the mixed dispersion and the pH of the mixed dispersion is adjusted to be acidic (for example, the pH is in the range of 2 to 5), after a dispersion stabilizer is added thereto according to the necessity, the temperature of the dispersion is heated to the glass transition temperature of the resin particles (specifically, for example, from the temperature lower than the glass transition temperature of resin particles by 30° C. to the temperature lower than the glass transition temperature of resin particles by 10° C.), the particles dispersed in the mixed dispersion are aggregated, and then aggregated particles are formed.

In the aggregated particle forming process, for example, the above-described coagulant is added thereto at room temperature (for example, 25° C.) while stirring the mixed dispersion by a rotary shearing type homogenizer, the pH of the mixed dispersion is adjusted to be acidic (for example, the pH is in the range of 2 to 5), a dispersion stabilizer is added thereto according to the necessity, and then the above-described heating may be performed.

Examples of the coagulant include a surfactant having an opposite polarity of a surfactant used as a dispersant to be added to the mixed dispersion, inorganic metal salts, and a di- or higher valent metal complex. Particularly, in a case where a metal complex is used as a coagulant, the amount of a surfactant to be used is decreased and the charging characteristics are improved.

Further, after the aggregation is completed, an additive forming a complex or a bond similar thereto with the metal ions of the coagulant may be added according to the necessity. As the additive, a chelating agent is preferably used. By adding the chelating agent, in a case where the coagulant is added in an excessive amount, adjustment of the content of metal ions of powder particles is achieved.

Here, metal salts, a metal salt polymer, or a metal complex as a coagulant is used as a supply source of metal ions. The examples thereof are as described above.

An aqueous chelating agent may be used as the chelating agent. Examples of the chelating agent include oxycarboxylic acid such as tartaric acid, citric acid, or gluconic acid; imino diacid (IDA); nitrilotriacetic acid (NTA); and ethylenediamine tetraacetic acid (EDTA).

The amount of the chelating agent to be added is preferably in the range of 0.01 parts by weight to 5.0 parts by weight and more preferably in the range of 0.1 parts by weight to less than 3.0 parts by weight with respect to 100 parts by weight of resin particles.

Coalescence Process

Next, the aggregated particle dispersion in which the aggregated particles are dispersed are heated at a temperature higher than or equal to the glass transition temperature of the resin particles (for example, at least a temperature higher by the range of 10° C. to 30° C. than the glass transition temperature of the resin particles), the aggregated particles are coalesced, and then toner particles are formed.

Toner particles are obtained by performing the above-described processes.

Further, after the aggregated particle dispersion in which aggregated particles are dispersed is obtained, toner particles may be produced by performing a process of forming second aggregated particles by mixing the aggregated particle dispersion and the resin particle dispersion in which resin particles are dispersed, and performing aggregation such that the resin particles are further adhered to the surface of the aggregated particles; and a process of forming toner particles having a core-shell structure by heating a second aggregated particle dispersion in which the second aggregated particles are dispersed, and coalescing the second aggregated particles.

Here, after the coalescence process is completed, toner particles in a state of being dried are obtained by applying a known washing process, a solid-liquid separation process, and a drying process to toner particles formed in a solution.

In the washing process, preferably, displacement washing using ion exchange water may be sufficiently performed in terms of the charging property. Further, the solid-liquid separation process is not particularly limited, but suction filtration, pressure filtration, and the like may preferably be performed in terms of productivity. Moreover, the method of the drying process is not particularly limited, but freeze-drying, flash jet drying, fluidizing drying, vibration type fluidizing drying, and the like may preferably be performed in terms of productivity.

Further, the toner according to the present exemplary embodiment is produced by adding an external additive to the obtained toner particles in a dry state and mixing the mixture. The mixing may be performed using a V blender, a Henschel mixer, or a Löedige mixer. Further, coarse particles of the toner may be removed using a vibration sieve or a wind classifier if necessary.

Electrostatic Charge Image Developer

An electrostatic charge image developer of the present exemplary embodiment contains at least the toner according to the present exemplary embodiment.

The electrostatic charge image developer according to the present exemplary embodiment may be a one-component developer containing only the toner according to the present exemplary embodiment or may be a two-component developer obtained by mixing the toner and a carrier.

The carrier is not particularly limited and known carriers may be exemplified. Examples of the carrier include a coated carrier in which the surface of a core made of magnetic particle is coated with a coating resin; a magnetic particle dispersion type carrier in which magnetic particle is dispersed and combined with a matrix resin; a resin impregnation type carrier in which porous magnetic particle is impregnated with a resin; and a resin dispersion type carrier in which conductive particles are dispersed and combined with a matrix resin.

Further, the magnetic particle dispersion type carrier, the resin impregnation type carrier, and the conductive particle dispersion type carrier may be carriers using constituent particles of the carrier as the core and coated with a coating resin.

Examples of the magnetic particle include magnetic metals such as iron, nickel, and cobalt; and magnetic oxides such as ferrite and magnetite.

Examples of the coating resin and the matrix resin include polyethylene, polypropylene, polystyrene, polyvinyl acetate, polyvinyl alcohol, polyvinyl butyral, polyvinyl chloride, polyvinyl ether, polyvinyl ketone, a vinyl chloride-vinyl acetate copolymer, a styrene-acrylic acid copolymer, a straight silicone resin having an organosiloxane bond or a modified product thereof, a fluorine resin, polyester, polycarbonate, a phenol resin, and an epoxy resin.

Further, other additives such as conductive particles may be contained in the coating resin and the matrix resin.

Examples of the conductive particles include particles of metals such as gold, silver, and copper, carbon black, titanium oxide, zinc oxide, tin oxide, barium sulfate, aluminum borate, and potassium titanate.

Examples of the method of coating the surface of a core with a coating resin include a method of coating the surface thereof with a solution for forming a coating layer obtained by dissolving a coating resin and various additives in an appropriate solvent according to the necessity. The solvent is not particularly limited and may be selected in consideration of a coating resin to be used, coating suitability, and the like.

Specific examples of the method of coating the surface with a resin include a dipping method of dipping a core in a solution for forming a coating layer; a spray method of spraying a solution for forming a coating layer to the surface of a core; a fluidized bed method of spraying a solution for forming a coating layer in a state in which a core is floated due to fluidized air; and a kneader coater method of mixing core of the carrier with a solution for forming a coating layer in a kneader coater and removing the solvent.

The mixing ratio (weight ratio) of the toner to the carrier (toner:carrier) in the two-component developer is preferably in the range of 1:100 to 30:100 and more preferably in the range of 3:100 to 20:100.

Image Forming Apparatus/Image Forming Method

An image forming apparatus and an image forming method according to the present exemplary embodiment will be described.

The image forming apparatus according to the present exemplary embodiment includes an image holding member; a charging unit that charges the surface of the image holding member; an electrostatic charge image forming unit that forms an electrostatic charge image on the surface of the charged image holding member; a developing unit that accommodates an electrostatic charge image developer and develops the electrostatic charge image formed on the surface of the image holding member as a toner image using the electrostatic charge image developer; a transfer unit that transfers the toner image formed on the surface of the image holding member to the surface of a recording medium; and a fixing unit that fixes the toner image transferred to the surface of the recording medium. In addition, the electrostatic charge image developer according to the present exemplary embodiment is applied as the electrostatic charge image developer.

In the image forming apparatus according to the present exemplary embodiment, an image forming method (image forming method according to the present exemplary embodiment) including a charging process of charging the surface of the image holding member; an electrostatic charge image forming process of forming an electrostatic charge image on the surface of the charged image holding member; a developing process of developing the electrostatic charge image formed on the surface of the image holding member as a toner image using the electrostatic charge image developer according to the present exemplary embodiment; a transfer process of transferring the toner image formed on the surface of the image holding member to the surface of a recording medium; and a fixing process of fixing the toner image transferred to the surface of the recording medium is performed.

Examples of the image forming apparatus according to the present exemplary embodiment include known image forming apparatuses such as an apparatus having a direct transfer system of directly transferring a toner image formed on a surface of an image holding member to a recording medium; an apparatus having an intermediate transfer system of primarily transferring a toner image formed on a surface of an image holding member to a surface of an intermediate transfer member and then secondarily transferring the toner image transferred to the surface of the intermediate transfer member to a surface of a recording medium; an apparatus including a cleaning unit that performs cleaning of a surface of an image holding member after transferring a toner image and before charging; and an apparatus including an erasing unit that performs erasing by irradiating a surface of an image holding member with erasing light and after transferring a toner image and before charging.

In the case of the apparatus having an intermediate transfer system, the transfer unit has a configuration including an intermediate transfer member to the surface of which a toner image is transferred; a primary transfer unit that primarily transfers the toner image formed on a surface of an image holding member to the surface of the intermediate transfer member; and a secondary transfer unit that secondarily transfers the toner image transferred to the surface of the intermediate transfer member to the surface of the recording medium.

In addition, in the image forming apparatus according to the present exemplary embodiment, a portion including the developing unit may have a cartridge structure (process cartridge) which is detachable from the image forming apparatus. As the process cartridge, for example, a process cartridge including the developing unit which accommodates the electrostatic charge image developer according to the present exemplary embodiment is preferably used.

Hereinafter, an example of the image forming apparatus according to the present exemplary embodiment will be described, but the present invention is not limited thereto. In addition, main elements illustrated in the figures are described and description of other elements is omitted.

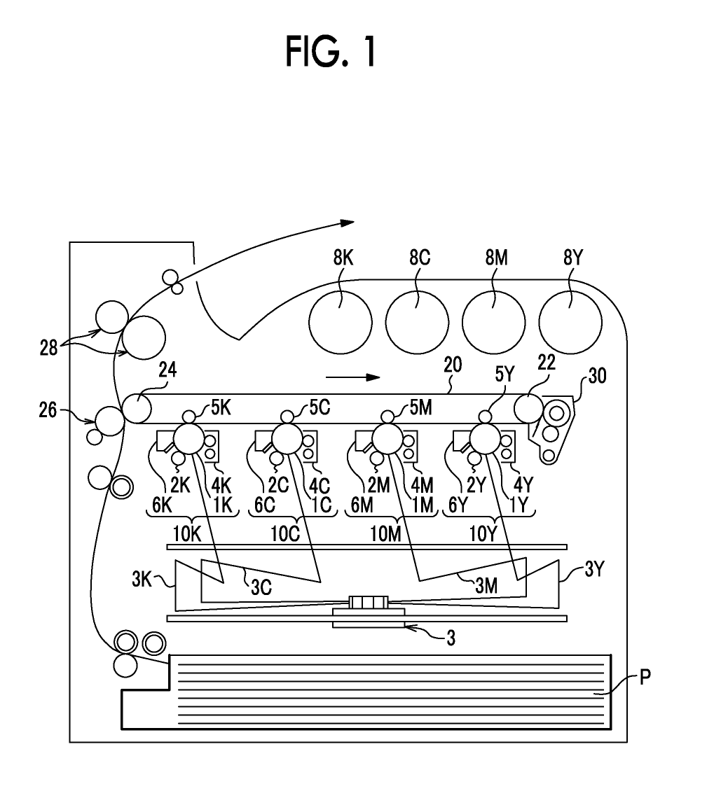

FIG. 1 is a view schematically illustrating the configuration of the image forming apparatus according to the present exemplary embodiment.

The image forming apparatus illustrated in FIG. 1 includes first to fourth image forming units 10Y, 10M, 10C, and 10K (image forming units) having an electrophotographic system of outputting images of respective colors of yellow (Y), magenta (M), cyan (C), and black (K) based on color-separated image data. These image forming units (hereinafter, simply referred to as “units” in some cases) 10Y, 10M, 10C, and 10K are disposed in parallel in a state of being separated from one another by a predetermined distance in the horizontal direction. Further, these units 10Y, 10M, 10C, and 10K may be process cartridges that are detachable from the image forming apparatus.

On the upper side in the figure of respective units 10Y, 10M, 10C, and 10K, an intermediate transfer belt 20 is extended as an intermediate transfer member through the respective units. The intermediate transfer belt 20 is provided in a state of being wound around a driving roll 22 and a support roll 24 in contact with the inner surface of the intermediate transfer belt 20, which are arranged by being separated from each other in the horizontal direction of the figure, and travels toward the fourth unit 10K from the first unit 10Y. Moreover, in the support roll 24, a force is applied to a direction away from the driving roll 22 due to a spring or the like (not illustrated) and tension is applied to the intermediate transfer belt 20 wound around the support roll and the driving roll. Further, an intermediate transfer member cleaning apparatus 30 is provided on the surface on the side of the image holding member of the intermediate transfer belt 20 so as to face the driving roll 22.

In addition, four toner colors, yellow, magenta, cyan, and black accommodated in toner cartridges 8Y, 8M, 8C, and 8K are supplied to respective developing devices (developing units) 4Y, 4M, 4C, and 4K of the respective units 10Y, 10M, 10C, and 10K.

Since the first to fourth units 10Y, 10M, 10C, and 10K have the same configuration, the first unit 10Y which is disposed on the upstream side in a travelling direction of the intermediate transfer belt and forms a yellow image will be described as a representative example. In addition, the description of the second to fourth units 10M, 10C, and 10K is omitted by denoting the reference numeral of magenta (M), cyan (C), or black (K) to a part equivalent to the first unit 10Y instead of yellow (Y).

The first unit 10Y includes a photoreceptor 1Y which is operated as an image holding member. A charging roll (an example of a charging unit) 2Y that charges the surface of the photoreceptor 1Y to a predetermined potential; an exposure device (an example of an electrostatic charge image forming unit) 3 that forms an electrostatic charge image by exposing the charged surface with laser light 3Y based on a color-separated image signal; a developing device (an example of a developing unit) 4Y that develops the electrostatic charge image by supplying a charged toner to the electrostatic charge image; a primary transfer roll 5Y (an example of a primary transfer unit) that transfers a developed toner image onto the intermediate transfer belt 20; and a photoreceptor cleaning device (an example of a cleaning unit) 6Y that removes a toner remaining on the surface of the photoreceptor 1Y after the primary transfer are arranged around the photoreceptor 1 in this order.

In addition, the primary transfer roll 5Y is arranged in the inside of the intermediate transfer belt 20 and provided in a position facing the photoreceptor 1. Further, bias power sources (not illustrated) applying primary transfer bias are respectively connected to each of the primary transfer rolls 5Y, 5M, 5C, and 5K. The respective bias power sources change the transfer bias applied to the respective primary transfer rolls through control of a control unit (not illustrated).

Hereinafter, an operation of forming a yellow image in the first unit 10Y will be described.

First, prior to the operation, the surface of the photoreceptor 1Y is charged to a potential of −600 V to −800 V by the charging roll 2Y.

The photoreceptor 1Y is formed by laminating a photosensitive layer on a conductive (for example, volume resistivity at 20° C.: 1×10⁻⁶ Ω·cm or less) substrate. The photosensitive layer has high resistance (resistant of a normal resin) in general, but the photosensitive layer has a property in which specific resistance of a portion irradiated with laser light is changed when the portion is irradiated with laser light 3Y. For this reason, the laser light 3Y is output to the surface of the charged photoreceptor 1Y through the exposure device 3 according to image data for yellow transmitted from the control unit (not illustrated). The photosensitive layer on the surface of the photoreceptor 1Y is irradiated with the laser light 3Y, and accordingly, an electrostatic charge image of a yellow image pattern is formed on the surface of the photoreceptor 1Y.

The electrostatic charge image is an image formed on the surface of the photoreceptor 1Y through charging and is a so-called negative latent image formed when the specific resistance on the portion of the photosensitive layer irradiated with the laser light 3Y is decreased, the charge on the surface of the photoreceptor 1Y flows, and the charge of the portion not irradiated with the laser light 3Y remains.

The electrostatic charge image formed on the photoreceptor 1Y is rotated to a predetermined developing position according to travelling of the photoreceptor 1Y. In addition, the electrostatic charge image on the photoreceptor 1Y is made into a visible image (developed image) as a toner image by the developing device 4Y in the developing position.

For example, an electrostatic charge image developer including at least a yellow toner and a carrier is accommodated in the developing device 4Y. The yellow toner is frictionally charged by being stirred in the inside of the developing device 4Y and is held on a developer roll (an example of a developer holding member) with a charge of the same polarity (negative polarity) as the charge on the photoreceptor 1Y. Further, when the surface of the photoreceptor 1Y passes through the developing device 4Y, the yellow toner is electrostatically adhered to an erased latent image portion on the surface of the photoreceptor 1Y and a latent image is developed by the yellow toner. The photoreceptor 1Y on which a yellow toner image is formed continuously travels at a predetermined speed and the toner image developed on the photoreceptor 1Y is transported to a predetermined primary transfer position.

When the yellow toner image on the photoreceptor 1Y is transported to the primary transfer position, primary transfer bias is applied to the primary transfer roll 5Y, the electrostatic force toward the primary transfer roll 5Y from the photoreceptor 1Y acts on the toner image, and the toner image on the photoreceptor 1Y is transferred onto the intermediate transfer belt 20. The transfer bias to be applied at this time is a positive (+) polarity which is an opposite polarity of the toner polarity (−) and is controlled to be +10 μA by a control unit (not illustrated) in the first unit 10Y, for example.

In addition, a toner remaining on the photoreceptor 1Y is removed by the photoreceptor cleaning device 6Y to be collected.

In addition, the primary transfer bias to be applied to primary transfer rolls 5M, 5C, and 5K of the second unit 10M and the subsequent units is controlled similarly to the first unit.

In this manner, the intermediate transfer belt 20 to which a yellow toner image is transferred in the first unit 10Y is sequentially transported through the second to fourth units 10M, 10C, and 10K, and toner images of respective colors, are multi-transferred in a superimposed manner.

The intermediate transfer belt 20 to which four colors of toner images are multi-transferred by passing through the first to fourth units reaches the secondary transfer portion formed of the intermediate transfer belt 20, the support roll 24 in contact with the inner surface of the intermediate transfer belt, and a secondary transfer roll (an example of a secondary transfer unit) 26 arranged on the image holding surface side of the intermediate transfer belt 20. In addition, the recording sheet (an example of a recording medium) P is fed to a void between the secondary transfer roll 26 and the intermediate transfer belt 20 in contact with each other through a supply mechanism at a predetermined timing, and the secondary transfer bias is applied to the support roll 24. The transfer bias to be applied at this time is the negative (−) polarity which is the same as the polarity (−) of a toner, the electrostatic force toward the recording sheet P from the intermediate transfer belt 20 acts on the toner image, and the toner image on the intermediate transfer belt 20 is transferred onto the recording sheet P. Further, the secondary transfer bias at this time is determined according to the resistance detected by a resistance detecting unit (not illustrated) that detects the resistance of the secondary transfer portion and the voltage thereof is controlled.

Next, the recording sheet P is sent to a pressure-contact unit (nip portion) of a pair of fixing rolls in a fixing device (an example of a fixing unit) 28, the toner image is fixed onto the recording sheet P, and a fixed image is formed.

As the recording sheet P to which a toner image is transferred, plain paper used in a copying machine or a printer having an electrophotographic system may be exemplified. As the recording medium, an OHP sheet may be exemplified in addition to the recording sheet P.

In order to further improve smoothness of the surface of the fixed image, the surface of the recording sheet P is also preferably smooth, and coated paper obtained by coating the surface of plain paper with a resin or the like or art paper for printing is preferably used.

The recording sheet P on which fixation of a color image is completed is discharged toward a discharge unit and a series of color image forming operations is completed.

Process Cartridge/Toner Cartridge

A process cartridge according to the present exemplary embodiment will be described.

The process cartridge according to the present exemplary embodiment is a process cartridge that accommodates the electrostatic charge image developer according to the present exemplary embodiment, includes a developing unit developing an electrostatic charge image formed on the surface of the image holding member as a toner image by the electrostatic charge image developer, and is detachable from the image forming apparatus.

In addition, the process cartridge according to the present exemplary embodiment may have a configuration, which is not limited to the above-described configuration, including a developing device and at least one unit selected from other units such as an image holding member, a charging unit, an electrostatic charge image forming unit, and a transfer unit according to the necessity.

Hereinafter, an example of the process cartridge according to the present exemplary embodiment will be described, but the present invention is not limited thereto. In addition, main elements illustrated in the figures are described and description of other elements is omitted.

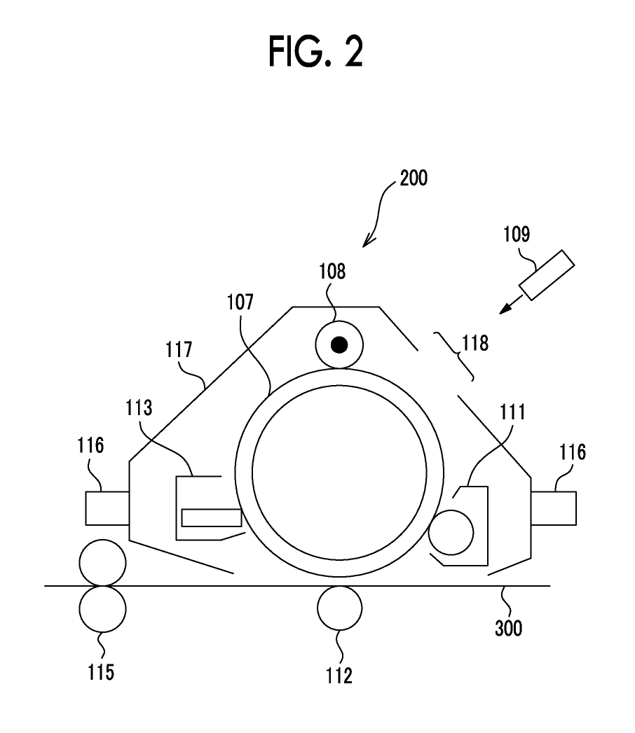

FIG. 2 is a view schematically illustrating the configuration of the process cartridge according to the present exemplary embodiment.

A process cartridge 200 illustrated in FIG. 2 is configured by integrally combining and holding a photoreceptor 107 (an example of an image holding member), and a charging roll 108 (an example of a charging unit), a developing device 111 (an example of a developing unit), and a photoreceptor cleaning device 113 (an example of a cleaning unit) which are provided around the photoreceptor 107, by a housing 117 including a mounting rail 116 and an opening portion 118 for exposure and made into a cartridge.

Further, in FIG. 2, the reference numeral 109 indicates an exposure device (an example of an electrostatic charge image forming unit), the reference numeral 112 indicates a transfer device (an example of a transfer unit), the reference numeral 115 indicates a fixing device (an example of a fixing unit), and the reference numeral 300 indicates recording sheet (an example of a recording medium).

Next, a toner cartridge according to the present exemplary embodiment will be described.

The toner cartridge according to the present exemplary embodiment is a toner cartridge that accommodates the toner according to the present exemplary embodiment and is detachable from an image forming apparatus. The toner cartridge accommodates a toner for replenishment to be supplied to a developing unit provided in the image forming apparatus.

Further, the image forming apparatus illustrated in FIG. 1 is an image forming apparatus having a configuration in which toner cartridges 8Y, 8M, 8C, and 8K are detachable from the image forming apparatus, and the developing devices 4Y, 4M, 4C, and 4K are connected to toner cartridges corresponding to respective developing devices (colors) and a toner supply tube (not illustrated). Further, in a case where the toner accommodated in the toner cartridge becomes depleted, the toner cartridge is exchanged.

### EXAMPLES

Hereinafter, the present exemplary embodiment will be described in detail based on Examples, but the present exemplary embodiment is not limited to Examples below. Further, in the description below, “parts” and “%” are on a weight basis unless otherwise noted.

Synthesis of Polyester Resin

Synthesis of Polyester Resin (A)

Bisphenol A propylene oxide 2 mol adduct: 100 parts by mole

Terephthalic acid: 30 parts by mole

Trimellitic acid anhydride: 20 parts by mole

Fumaric acid: 50 parts by mole

Dibutyltin oxide: 0.6 parts by mole

The above-described components are put into a heated and dried three-necked flask, nitrogen gas is introduced into the flask to be an inert atmosphere, the temperature therein is raised while the inert atmosphere is maintained, a polycondensation reaction is performed at 210° C. for 3 hours, the pressure therein is slowly reduced at 230° C., and a polyester resin (A) is synthesized.

In this resin, the ratio of monomers having an ethylenically unsaturated double bond to a total amount of polyvalent carboxylic acid and polyol is 25% by mole and the ethylenically unsaturated double bond equivalent is 800 g/eq. Further, the polyester resin (A) is unsaturated.

Synthesis of Polyester Resin (B)

A polyester resin (B) is synthesized in the same procedures as those of the polyester resin (A) except that the components are changed into 60 parts by mole of terephthalic acid, 46 parts by mole of trimellitic acid anhydride, and 4 parts by mole of fumaric acid.

In this resin, the ratio of monomers having an ethylenically unsaturated double bond to a total amount of polyvalent carboxylic acid and polyol is 4% by mole and the ethylenically unsaturated double bond equivalent is 4200 g/eq. Further, the polyester resin (B) is unsaturated.

Synthesis of Polyester Resin (C)

A polyester resin (C) is synthesized in the same procedures as those of the polyester resin (A) except that 60 parts by mole of terephthalic acid, and 40 parts by mole of trimellitic acid anhydride are used in place of the above-described components. Further, the polyester resin (C) is saturated.

Preparation of Polyester Resin Particle Dispersion

Preparation of Polyester Resin Particle Dispersion (1)

171 parts by weight of the polyester resin (A) and 800 parts by weight of methyl ethyl ketone are put into a separable flask and mixed and dissolved at 75° C., 10% by weight of an ammonia aqueous solution is added dropwise thereto by an amount of 6 parts by weight thereof. The heating temperature is decreased to 60° C., ion exchange water is added dropwise at a liquid sending speed of 6 g/min using a liquid sending pump while stirring, the liquid sending speed is raised to 25 g/min after the liquid is clouded, and dropwise addition of ion exchange water is stopped when the total amount of liquid added by dropwise addition is 400 parts by weight. Next, the solvent is removed under the reduced pressure. Subsequently, the solid content concentration is adjusted by adding ion exchange water and 0.05 parts by weight of n-butyl acrylate as (meth)acrylic acid alkyl ester to the obtained dispersion, thereby obtaining a polyester resin particle dispersion (1). The volume average particle diameter of the obtained polyester resin particle dispersion (1) is 168 nm and the solid content concentration is 30% by weight.

Preparation of Polyester Resin Particle Dispersion (2)

A polyester resin particle dispersion (2) is obtained in the same manner as that of the polyester resin particle dispersion (1) except that methyl acrylate is used in place of n-butyl acrylate.

Preparation of Polyester Resin Particle Dispersion (3)

A polyester resin particle dispersion (3) is obtained in the same manner as that of the polyester resin particle dispersion (1) except that decyl acrylate is used in place of n-butyl acrylate.

Preparation of Polyester Resin Particle Dispersion (4)

A polyester resin particle dispersion (4) is obtained in the same manner as that of the polyester resin particle dispersion (1) except that dodecyl acrylate is used in place of n-butyl acrylate.

Preparation of Polyester Resin Particle Dispersion (5)

A polyester resin particle dispersion (5) is obtained in the same manner as that of the polyester resin particle dispersion (1) except that a polyester resin (C) is used in place of a polyester resin (A).

Preparation of Polyester Resin Particle Dispersion (6)

A polyester resin particle dispersion (6) is obtained in the same manner as that of the polyester resin particle dispersion (1) except that the amount of n-butyl acrylate is changed to 0.01 parts by weight.

Preparation of Polyester Resin Particle Dispersion (7)

A polyester resin particle dispersion (7) is obtained in the same manner as that of the polyester resin particle dispersion (1) except that the amount of n-butyl acrylate is changed to 0.02 parts by weight.

Preparation of Polyester Resin Particle Dispersion (8)

A polyester resin particle dispersion (8) is obtained in the same manner as that of the polyester resin particle dispersion (1) except that the amount of n-butyl acrylate is changed to 0.03 parts by weight.

Preparation of Polyester Resin Particle Dispersion (9)

A polyester resin particle dispersion (9) is obtained in the same manner as that of the polyester resin particle dispersion (1) except that the amount of n-butyl acrylate is changed to 0.08 parts by weight.

Preparation of Polyester Resin Particle Dispersion (10)

A polyester resin particle dispersion (10) is obtained in the same manner as that of the polyester resin particle dispersion (1) except that the amount of n-butyl acrylate is changed to 0.12 parts by weight.

Preparation of Polyester Resin Particle Dispersion (11)

A polyester resin particle dispersion (11) is obtained in the same manner as that of the polyester resin particle dispersion (1) except that the amount of n-butyl acrylate is changed to 0.13 parts by weight.

Preparation of Polyester Resin Particle Dispersion (12)

A polyester resin particle dispersion (12) is obtained in the same manner as that of the polyester resin particle dispersion (1) except that a polyester resin (B) is used in place of a polyester resin (A).

Preparation of Colorant Particle Dispersion

Preparation of Colorant Particle Dispersion (1)

Cyan pigment: 10 parts by weight [Pigment Blue 15:3, manufactured by Dainichiseika Color & Chemicals Mfg. Co., Ltd.]

Anionic surfactant: 2 parts by weight [Neogen SC, manufactured by Dai-ichi Kogyo Seiyaku Co., Ltd.]

Ion exchange water: 80 parts by weight

The above-described components are mixed with each other and dispersed using a high pressure impact type disperser Ultimizer [HJP30006, manufactured by SUGINO MACHINE LIMITED] for 1 hour, thereby obtaining a colorant particle dispersion (1) having a volume average particle diameter of 180 nm and a solid content of 20% by weight.

Preparation of Release Agent Particle Dispersion

Release Agent Particle Dispersion (1)

Carnauba wax: 50 parts by weight [RC-160, melting temperature: 84° C., manufactured by Toa Kasei Co., Ltd.]

Anionic surfactant: 2 parts by weight [Neogen SC, manufactured by Dai-ichi Kogyo Seiyaku Co., Ltd.]

Ion exchange water: 200 parts by weight

The above-described components are heated to 120° C., mixed and dispersed using an Ultra-Turrax T50 (manufactured by IKA, Inc.), and subjected to a dispersion treatment using a pressure ejection type homogenizer, thereby obtaining a release agent particle dispersion (1) having a volume average particle diameter of 200 nm and a solid content of 20% by weight.

### Example 1

### Preparation of Toner (1)

Polyester resin particle dispersion (1): 400 parts by weight

Colorant particle dispersion (1): 15 parts by weight

Release agent particle dispersion (1): 25 parts by weight

Ion exchange water: 1000 parts by weight

The above-described components are dispersed in a round stainless steel flask such that respective components are sufficiently mixed with one another using a homogenizer (Ultra-Turrax T50, manufactured by IKA, Inc.). Next, 5 parts by weight of a 10% polyaluminum chloride aqueous solution is added to the dispersion, and the contents in the flask are stirred using a water bath. After the dispersed state is confirmed, the contents are stirred using a three-one motor (BLh300, manufactured by Shinto Scientific Co., Ltd.) at a stirring rotation speed of 150 rpm and heated and stirred to a temperature of 45° C. at a temperature raising rate of 0.5° C./min, and the state is maintained at 45° C. for 60 minutes. Subsequently, 250 parts by weight of an additional polyester resin particle dispersion (1) is added thereto and then the contents are further stirred for 60 minutes. When the obtained contents are observed using an optical microscope, it is confirmed that aggregated particles having a particle diameter of 4.0 μm are generated. 0.5 parts by weight of a 30% EDTA aqueous solution is added thereto and the pH thereof is adjusted to 7.5 with a 0.8 M sodium hydroxide aqueous solution. Next, after the temperature is increased, the aggregated particles are coalesced at 95° C. for 5 hours, cooled, filtered, sufficiently washed with ion exchange water, and dried, thereby obtaining toner particles (1) having a volume average particle diameter of 5.1 μm.

Subsequently, 3.3 parts by weight of hydrophobic silica particles (RY50, manufactured by Nippon Aerosil Co., Ltd.) are added to 100 parts by weight of the toner particles (1) as an external additive. Next, the mixture is mixed using a Henschel mixer at a rotation speed of 30 m/s for 3 minutes. Subsequently, the mixture is sieved using a vibration sieve having a mesh of 45 μm, thereby obtaining a toner (1).

### Examples 1 to 8 and Comparative Examples 1 to 4

### Preparation of Toners (2) to (11) and (13)

Toners (2) to (11) and (13) are prepared in the same manner as that of the toner (1) except that the kind of polyester resin particle dispersion (written as “PE dispersion” in Table below) is changed according to Table 1 in place of the polyester resin particle dispersion (1) (including the additional amount).

### Examples 9 and 10 and Comparative Example 5

### Preparation of Toners (12), (14), and (15)

Toners (12), (14), and (15) are prepared in the same manner as that of Example 1 except that the amount of polyaluminum chloride or the kind and the amount of the compound containing metal ions are changed according to the kind and the content of metal ions listed in Table 1.

Measurement/Evaluation

The prepared toners described above are measured by following a method in the related art in regard to the content of (meth)acrylic acid alkyl ester (written as “alkyl-(M) A” in Table 1) and metal ions.

Preparation of Developer 8 parts by weight of the toners (1) to (15) prepared as described above and 92 parts by weight of the carrier (A) described below are put into a V blender, stirred for 20 minutes, and sieved using a sieve having a mesh of 105 μm, thereby preparing developers (1) to (15) respectively.

Preparation of Carrier (A)

Ferrite particles (volume average particle diameter: 50 μm):

100 parts by weight

Toluene: 100 parts by weight, 15 parts by weight

Styrene-methyl methacrylate copolymer (component molar ratio: 90/10): 2 parts by weight

Carbon black (R330, manufactured by Cabot Corporation): 0.25 parts by weight

First, a coating liquid in which the above-described components other than the ferrite particles are stirred using a stirrer for 10 minutes, and dispersed is prepared, the coating liquid and ferrite particles are put into a vacuum degassing type kneader, the contents are stirred at 60° C. for 25 minutes, the pressure is reduced while the temperature therein is increased, and the kneader is degassed and dried, thereby preparing a carrier A. The carrier (A) has a shape factor of 120, a true specific gravity of 4.4, a saturation magnetization of 63 emu/g, and a volume resistivity of 1000 Ω·cm at the time applying an electric field of 1000 V/cm.

Evaluation of Change in Glossiness

A developing device of “Versant(trademark) 2100 Press” (manufactured by Fuji Xerox Co., Ltd.) is filled with the obtained developers. A solid image having a dimension of 1 cm×1 cm and a toner mounting amount of 0.3 mg/cm² is formed on white paper of A4 size (J-A4 paper, manufactured by Fuji Xerox Co., Ltd.) using the developing device.

The white paper on which a solid image is formed is kept in an environment exposed to radiation having an intensity of 2000 mJ/cm² at a temperature of 50° C., and a humidity of 80% RH for 240 hours. 60° glossiness of the original image before being kept and the kept image after being kept is measured using a glossiness meter (micro-TRI-Glossiness: manufactured by Gardner, Inc.).

A change in 60° glossiness of the solid image before and after being kept is evaluated based on the following criteria.

Evaluation Criteria—

A(©): The change in glossiness between the original image and the kept image does not appear, which is excellent.
B(O): The change in glossiness of the kept image compared to the original image is less than 5%, and the difference is not almost recognized.
C(Δ): The change in glossiness of the kept image compared to the original image is in the range of 5% to less than 10%, which is not problematic as the glossiness of an image.
D(X): The change in glossiness of the kept image compared to the original image is 10% or more, and the difference is evidently recognized.

Hereinafter, the details of respective examples and the evaluation results are listed in Table 1 as shown below.

TABLE 1

| | | PE dispersion | | | | | | | |
|---|---|---|---|---|---|---|---|---|---|
| | | | PE | | alkyl-(M)A | | Toner | | Evaluation |
| | Toner | | | Unsaturated | | Number | alkyl-(M)A | Metal ions | Change in |
| | No. | No. | Type | or saturated | Type | of parts | content | Type/content | glossiness |
| Example 1 | 1 | 1 | A | Unsaturated | n-Butyl acrylate (C4) | 0.05 | 200 ppm | Al³⁺/0.006% by weight | A( ©) |
| Example 2 | 2 | 2 | A | Unsaturated | Methyl acrylate (C1) | 0.05 | 200 ppm | Al³⁺/0.006% by weight | C(Δ) |
| Example 3 | 3 | 3 | A | Unsaturated | n-Decyl acrylate (C10) | 0.05 | 200 ppm | Al³⁺/0.006% by weight | C(Δ) |
| Comparative | 4 | 4 | A | Unsaturated | n-Dodecyl acrylate (C12) | 0.05 | 200 ppm | Al³⁺/0.006% by weight | D(X) |
| Example 1 | | | | | | | | | |
| Comparative | 5 | 5 | C | Saturated | n-Butyl acrylate (C4) | 0.05 | 200 ppm | Al³⁺/0.006% by weight | D(X) |
| Example 2 | | | | | | | | | |
| Comparative | 6 | 6 | A | Unsaturated | n-Butyl acrylate (C4) | 0.01 | 40 ppm | Al³⁺/0.006% by weight | D(X) |
| Example 3 | | | | | | | | | |
| Example 4 | 7 | 7 | A | Unsaturated | n-Butyl acrylate (C4) | 0.02 | 60 ppm | Al³⁺/0.006% by weight | C(Δ) |
| Example 5 | 8 | 8 | A | Unsaturated | n-Butyl acrylate (C4) | 0.03 | 100 ppm | Al³⁺/0.006% by weight | B(◯) |
| Example 6 | 9 | 9 | A | Unsaturated | n-Butyl acrylate (C4) | 0.08 | 300 ppm | Al³⁺/0.006% by weight | B(◯) |
| Example 7 | 10 | 10 | A | Unsaturated | n-Butyl acrylate (C4) | 0.12 | 480 ppm | Al³⁺/0.006% by weight | C(Δ) |
| Comparative | 11 | 11 | A | Unsaturated | n-Butyl acrylate (C4) | 0.13 | 510 ppm | Al³⁺/0.006% by weight | D(X) |
| Example 4 | | | | | | | | | |
| Comparative | 12 | 1 | A | Unsaturated | n-Butyl acrylate (C4) | 0.05 | 200 ppm | Na¹⁺/0.06% by weight | D(X) |
| Example 5 | | | | | | | | | |
| Example 8 | 13 | 12 | B | Unsaturated | n-Butyl acrylate (C4) | 0.05 | 200 ppm | Al³⁺/0.006% by weight | C(Δ) |
| Example 9 | 14 | 1 | A | Unsaturated | n-Butyl acrylate (C4) | 0.05 | 200 ppm | Mg²⁺/0.006% by weight | C(Δ) |
| Example 10 | 15 | 1 | A | Unsaturated | n-Butyl acrylate (C4) | 0.05 | 200 ppm | Al³⁺/0.003% by weight | C(Δ) |

From the results described above, the change in glossiness of an image is prevented in Examples compared to Comparative Examples.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An electrostatic charge image developing toner, comprising toner particles containing a binder resin that contains a polyester resin having an ethylenically unsaturated double bond, a di- or higher valent metal ion, and (meth)acrylic acid alkyl ester that has an alkyl chain having 1 to 10 carbon atoms, wherein a content of the (meth)acrylic acid alkyl ester is in a range of 50 ppm to 500 ppm with respect to toner particles.

2. The electrostatic charge image developing toner according to claim 1, wherein the number of carbon atoms of an alkyl chain of the (meth)acrylic acid alkyl ester is in a range of 3 to 6.

3. The electrostatic charge image developing toner according to claim 1, wherein the content of the (meth)acrylic acid alkyl ester is in a range of 100 ppm to 300 ppm with respect to toner particles.

4. The electrostatic charge image developing toner according to claim 1, wherein the polyester resin is a polycondensate of polyvalent carboxylic acid having an ethylenically unsaturated double bond and polyol.

5. The electrostatic charge image developing toner according to claim 4, wherein the polyvalent carboxylic acid having an ethylenically unsaturated double bond contains carboxylic acid selected from the group consisting of fumaric acid, maleic acid, and maleic anhydride.

6. The electrostatic charge image developing toner according to claim 1, wherein a ratio of monomers having an ethylenically unsaturated double bond to a total amount of polyvalent carboxylic acid and polyol of the polyester resin having an ethylenically unsaturated double bond is in a range of 5% by mole to 25% by mole.

7. The electrostatic charge image developing toner according to claim 1, wherein a ratio of monomers having an ethylenically unsaturated double bond to a total amount of polyvalent carboxylic acid is in a range of 12.5% by mole to 60% by mole.

8. The electrostatic charge image developing toner according to claim 1, wherein an ethylenically unsaturated double bond equivalent of the polyester resin is 4000 g/eq or less.

9. The electrostatic charge image developing toner according to claim 4, wherein the polyvalent carboxylic acid of a polyester resin having an ethylenically unsaturated double bond contains fumaric acid.

10. The electrostatic charge image developing toner according to claim 4, wherein the polyol contains a bisphenol A alkylene oxide adduct.

11. The electrostatic charge image developing toner according to claim 1, wherein a glass transition temperature of the polyester resin having an ethylenically unsaturated double bond is in a range of 50° C. to 80° C.

12. The electrostatic charge image developing toner according to claim 1, wherein a weight average molecular weight of the polyester resin having an ethylenically unsaturated double bond is in a range of 5000 to 1000000.

13. The electrostatic charge image developing toner according to claim 1, wherein a molecular weight distribution Mw/Mn of the polyester resin having an ethylenically unsaturated double bond is in a range of 1.5 to 100.

14. The electrostatic charge image developing toner according to claim 1, wherein the content of the metal ion is in a range of 0.005% by weight to 0.800% by weight.

15. The electrostatic charge image developing toner according to claim 1, further comprising a colorant,
wherein a content of the colorant is in a range of 1% by weight to 30% by weight with respect to the entirety of toner particles.

16. The electrostatic charge image developing toner according to claim 1, further comprising a release agent,
wherein a melting temperature of the release agent is in a range of 50° C. to 110° C.

17. The electrostatic charge image developing toner according to claim 1, wherein a shape factor SF1 is in a range of 110 to 150.

18. An electrostatic charge image developer comprising the electrostatic charge image developing toner according to claim 1.

19. The electrostatic charge image developer according to claim 18, further comprising a carrier that contains carbon black in a resin coating layer.

20. A toner cartridge that accommodates the electrostatic charge image developing toner according to claim 1 and is detachable from an image forming apparatus.
